(19) United States
(12) Patent Application Publication
(10) Pub. No.: US 2013/0220178 A1
(43) Pub. Date: Aug. 29, 2013

(54) Re-Dispersible Metal Oxide Nanoparticles and Method of Making Same

(71) Applicants: Roman Zieba, Munchen (DE); Alexander Traut, Schriesheim (DE); Cornelia Röger-Göpfert, Weinheim (DE); Torsten Brezesinski, Karlsruhe (DE); Bernadette Landschreiber, Heuchelheim (DE); Claudia Grote, Braunschweig (DE); Georg Garnweitner, Braunschweig (DE); Alexandra Seeber, Shah Alam (MY); Bernd Smarsly, Pohlheim (DE); Christoph Wiedmann, Eggenstein-Leopoldshafen (DE); Till von Graberg, Heidelberg (DE); Jan Haetge, Nieder Florstadt (DE)

(72) Inventors: Roman Zieba, Munchen (DE); Alexander Traut, Schriesheim (DE); Cornelia Röger-Göpfert, Weinheim (DE); Torsten Brezesinski, Karlsruhe (DE); Bernadette Landschreiber, Heuchelheim (DE); Claudia Grote, Braunschweig (DE); Georg Garnweitner, Braunschweig (DE); Alexandra Seeber, Shah Alam (MY); Bernd Smarsly, Pohlheim (DE); Christoph Wiedmann, Eggenstein-Leopoldshafen (DE); Till von Graberg, Heidelberg (DE); Jan Haetge, Nieder Florstadt (DE)

(73) Assignee: Justus-Liebig-Universitat Giessen, Giessen (DE)

(21) Appl. No.: 13/501,688

(22) PCT Filed: Oct. 7, 2010
(86) PCT No.: PCT/EP2010/064970

§ 371 Date: Apr. 17, 2013

(30) Foreign Application Priority Data
Oct. 13, 2009 (EP) 09172909.5

(51) Int. Cl. C01B 13/32; C01G 33/00; C01G 35/00; C01G 27/02; C01G 25/02; C01B 13/00; C01F 7/02; C01G 49/06; C01G 37/033; C01G 31/02; C01G 55/00; C01G 30/00; C01G 23/053; C01G 45/02

(52) U.S. Cl. CPC C01B 13/32; C01G 23/053; C01G 33/00; C01G 35/00; C01G 27/02; C01G 25/02; C01G 45/02; C01F 7/02; C01G 49/06; C01G 37/033; C01G 31/02; C01G 55/004; C01G 30/005; C01B 13/00
USPC 106/287.17; 423/592.1; 423/625; 423/618; 423/617; 423/619; 423/624; 423/636; 423/608; 423/594.17; 423/605; 423/632; 423/607; 106/287.19; 106/287.18

(57) ABSTRACT

The current invention relates to a method of making metal oxide nanoparticles comprising the reaction of—at least one metal oxide precursor (P) containing at least one metal (M) with—at least one monofunctional alcohol (A) wherein the hydroxy group is bound to a secondary, tertiary or alpha-unsaturated carbon atom—in the presence of at least one aliphatic compound (F) according to the formula Y¹—R¹—X—R²—Y², wherein—R¹ and R² each are the same or different and independently selected from aliphatic groups with from 1 to 20 carbon atoms, —Y¹ and Y² each are the same or different and independently selected from OH, NH₂ and SH, and —X is selected from the group consisting of chemical bond, —O—, —S—, —NR³—, and CR⁴R⁵, wherein R³, R⁴ and R⁵ each are the same or different and represent a hydrogen atom or an aliphatic group with from 1 to 20 carbon atoms which optionally carries functional groups selected from OH, NH₂ and SH. This invention also relates to metal oxide nanoparticles, to a method of making dispersions of said nanoparticles and to dispersions containing them.

The current invention relates to a method of making metal oxide nanoparticles comprising the reaction of
at least one metal oxide precursor (P) containing at least one metal (M) with
at least one monofunctional alcohol (A) wherein the hydroxy group is bound to a secondary, tertiary or α-unsaturated carbon atom
in the presence of at least one aliphatic compound (F) according to the formula Y¹—R¹—X—R²—Y², wherein
R¹ and R² each are the same or different and independently selected from aliphatic groups with from 1 to 20 carbon atoms,
Y¹ and Y² each are the same or different and independently selected from OH, NH₂ and SH, and
X is selected from the group consisting of chemical bond, —O—, —S—, —NR³—, and —CR⁴R⁵, wherein R³, R⁴ and R⁵ each are the same or different and represent a hydrogen atom or an aliphatic group with from 1 to 20 carbon atoms which optionally carries functional groups selected from OH, NH₂ and SH.

This invention also relates to metal oxide nanoparticles, to a method of making dispersions of said nanoparticles and to dispersions containing them.

Methods for preparing metal oxide nanoparticles are well known in the art. The most common techniques are precipitation, sol-gel synthesis, the so called Pechini method, microemulsion synthesis and solvothermal (hydrothermal) synthesis.

The sol-gel method is the most versatile of these methods due to its practicability and because a broad range of metal oxides are accessible. In case of highly reactive pre-cursors, e.g., metal halides, the kinetics of hydrolytic sol-gel processes as well as the size and structure of the nanoparticles is difficult to control. Non-hydrolytic (water-free) sol gel processes have therefore been developed in the prior art, in which the metal salt reacts more slowly with an organic solvent (mostly alcohol) to yield nanoparticular metal oxides.

DE 103 23 816 discloses a method of making mixed metal oxides by means of reacting metal alcoholates with metal salts such as hydroxides, carboxylates, or carbonates in C₁ to C₈-alcohols or glycol ethers at a temperature of 50 to 200° C. The process is performed under non-hydrolytic conditions and leads to suspensions of mixed metal oxide nanoparticles with particle diameters of below 10 nm. However the degree of aggregation of the nanoparticles obtained in this method as well as their re-dispersability needs still to be improved.

WO2005/021426 and WO2005/095278 describe the synthesis of metal oxide nanoparticles (e.g. BaTiO₃, V₂O₅, HfO₂, Nb₂O₅) from alkoxides by heating one or more metal oxide precursors in benzyl alcohol at temperatures above 200° C. in an autoclave. The product of this method is a powder containing agglomerated nanoparticles.

Niederberger et. al., Angew. Chem. Int. Ed. 2004, 43, 2270 describe a similar method for the preparation of perovskites, e.g., BaTiO₃ or LiNbO₃, where reactive metals Li and Ba are dissolved in benzyl alcohol and alkoxides are used as Ti or Nb sources. The product of this method is a powder containing agglomerated nanoparticles.

For applications which use nanoparticles as precursors for nanostructured materials (e.g. mesoporous films), the possibility to obtain stable dispersions of individual, i.e., non-agglomerated, nanoparticles is important. In other words, for such applications metal oxide nanoparticles should be easily re-dispersible and thus lead to a stable dispersion upon addition of suitable solvents.

In order to obtain stabilized individual nanoparticles and prevent their agglomeration, it was suggested in the prior art to modify the surface of the nanoparticles by surface modifying agents which prevent the contact between individual nanoparticles through sterical interaction. In principle, the modification of nanoparticle surfaces can be achieved through post-synthetic modification or through in-situ modification by adding a surface modifying agent directly to the reaction mixture. The advantage of the in-situ modification lies in the simultaneous control of particle growth and surface stabilization. Corresponding methods are known from the prior art.

On the other hand, there is a need in the art for a method which leads to the formation of transparent and aggregate-free dispersions of metal oxide nanoparticles with diameters of primary particles of below 10 nm and a narrow size distribution.

Niederberger et. al. Chem. Mater., 2004, 16, 1202 describe a non-aqueous sol-gel synthesis of TiO2 nanoparticles. Dopamine and tert.-Butylcatechol are used as surface modifiers in an in-situ modification method. The product of this method is re-dispersible nanoparticulate titanium dioxide. However the surface modification as suggested by Niederberger et al. induces discoloration of the titanium dioxide which is undesirable for many applications.

The methods for making re-dispersible nanoparticulate metal oxides known from the prior art furthermore lack reproducibility and versatility. The degree of re-dispersibility of highly crystalline nanoparticles into aggregate-free and clear solutions still is insufficient for many applications. Also, the known methods only work for specific types of metal oxides.

In the prior art it has been suggested to obtain re-dispersible metal oxide nanoparticles via a post-synthesis surface functionalisation of the metal oxide nanoparticles with bulky organic ligands which is however disadvantageous for applications in which the electrical resistance is of concern.

It was an objective of the present invention to provide metal oxide nanoparticles which can be stored in solid state as powder at ambient temperature and easily re-dispersed into non-agglomerated dispersions of nanoparticles in suitable solvents and avoid the above mentioned disadvantages. The method ought to be versatile with respect to different metal oxides.

It was another objective of the present invention to provide a general synthetic approach which is applicable to a broad range of different metal and mixed metal oxides, e.g., ternary metal oxides, and which leads to precipitated metal oxide nanoparticles which nevertheless are easily re-dispersible into a stable non-agglomerated dispersion upon addition of organic solvents.

Both, amorphous as well as crystalline metal oxide nanoparticles ought to be accessible by this method. It was an objective to provide stable dispersions of nanoparticles upon addition of a suitable solvent. It was yet another objective of the present invention to provide stabilized metal oxide nanoparticles where the stabilization imposes no color to the nanoparticles. The size of nanoparticles as well as the crystallinity of the metal oxides ought to be tunable.

The before-mentioned problems are solved by the inventive method and by the metal oxides and dispersions obtainable by said method. Preferred embodiments are outlined in the following and in the claims. Combinations of preferred embodiments do not leave the scope of the present invention.

The method of making metal oxide nanoparticles according to the invention comprises the reaction of
at least one metal oxide precursor (P) containing at least one metal (M) with
at least one monofunctional alcohol (A) wherein the hydroxy group is bound to a secondary, tertiary or α-unsaturated carbon atom
in the presence of at least one aliphatic compound (F) according to the formula Y¹—R¹—X—R²—Y², wherein
R¹ and R² each are the same or different and independently selected from aliphatic groups with from 1 to 20 carbon atoms,
Y¹ and Y² each are the same or different and independently selected from OH, NH₂ and SH, and
X is selected from the group consisting of chemical bond, —O—, —S—, —NR³—, and —CR⁴R⁵, wherein R³, R⁴ and R⁵ each are the same or different and represent a hydrogen atom or an aliphatic group with from 1 to 20 carbon atoms which optionally carries functional groups selected from OH, NH and SH.

In the following the at least one monofunctional alcohol as defined above is referred to as component (A). The at least one metal oxide precursor (P) as defined above is referred to as component (P). The at least one aliphatic compound (F) as defined above is referred to as component (F).

Component (P)

According to the invention at least one metal oxide precursor (P) containing at least one metal (M) is used. The term “metal oxide precursor” throughout the present invention refers to a metal compound which is convertible into metal oxides by means of hydrolysis, solvolysis, and/or thermal treatment. Such metal oxide precursors are known to the person skilled in the art.

The term “metal oxide” throughout the present invention refers to pure or mixed metal oxides, i.e. to binary oxides containing one metal as well as to ternary or higher oxides. The same term also refers to pure oxides or mixed oxide/oxide hydrates. It is known to the person skilled in the art that metal oxides may contain —OH and/or H₂O-ligands in addition to oxygen, in particular on the surface.

In principle, the method according to the invention is a general method which can be applied to any metal forming stable metal oxides. The at least one metal (M) is preferably selected from transition metals and main group metals provided that at least one metal (M) is neither an alkaline metal nor an alkaline earth metal.

Preferably component (P) contains at least one metal selected from the group consisting of transition metals, Al, Sn, Sb, Pb, In, and Ba.

It is particularly preferred if component (P) contains at least one metal selected from the group consisting of Ti, Nb, Ta, Zr, Mn, Al, Fe, Cr, Sn, Sb, Pb, Ce, In, Ba and V.

If desired, doping elements such as Mg, Ca, Zn, Zr, V, Nb, Ta, Bi, Cr, Mo, W, Mn, Fe, Co, Ni, Pb, Ce, Sb, Al, Sn, In, Ga or mixtures thereof, preferably Mg, Ca, Cr, Fe, Co, Ni, Pb, Sb, Al, Sn, In, Ga or mixtures thereof, can be present, in particular in the form of their hydroxides, oxides, carbonates, carboxylates or nitrates.

Preferred metal oxide precursors (P) are ionic metal compounds containing at least one metal cation and at least one anionic group frequently referred to as anion and/or ionic ligand. The precursors (P) may in addition contain non-ionic ligands. The metal oxide precursors (P) may in particular contain at least one non-ionic ligand selected from water, alcohols, in particular methanol, ethanol, isopropanol, dimethoxyethane, acetylacetone and pentanedione.

Preferred anionic groups are halides, in particular chloride or bromide, sulphates, phosphates, nitrates, carbonates, carboxylates, acetylacetonates, acetylacetates, alkoxides, in particular methoxide, ethoxide, isopropoxide, n-butoxide, iso-butoxide or tert.-butoxide and mixtures thereof. Suitable metal oxide precursors (P) may contain one sort of anionic group or two or more different anionic groups.

The selection of anionic groups depends on the nature of the at least one metal (M) as well as on the nature of the alcohol (A). Any of the before mentioned ligands is suitable provided the corresponding metal oxide precursor (P) is convertible into a metal oxide. The person skilled in the art selects ligands from the list of suitable ligands once the at least one metal (M) and therefore the nature of the targeted metal oxide has been chosen. Suitable ligands can be selected by routine testing.

If the metal M is Ti then alkoxides and chlorides are preferred, in particular TiCl₄ and Ti(OiPr)₄. If the metal M is Nb then halides, preferably chlorides, are advantageous, in particular NbCl₅. If the metal M is Ta then alkoxides are preferred, in particular Ta(OEt)₅. If the metal is Hf then halides, in particular chlorides, preferably HfCl₄, are advantageous. If the metal M is Zr then halides, in particular chlorides, preferably ZrCl₄, are advantageous. If the metal M is Mn then nitrates are preferred, in particular Mn(NO₃)₂·xH₂O. If the metal M is Al then halides, in particular chlorides, preferably AlCl₃, are preferred. If the metal M is Hf then halides, in particular chlorides, preferably HfCl₄, are advantageous. If the metal M is Fe then nitrates are preferred, in particular Fe(NO₃)₃·9H₂O. If the metal M is Cr then nitrates are preferred, in particular Cr(NO₃)₃·9H₂O. If the metal M is V then alkoxides are preferred, in particular V(OEt)₃. If the metal M is Ru then halides, in particular chlorides, preferably RuCl₃·xH₂O, are advantageous. If the metal M is Sn then halides, in particular chlorides, preferably SnCl₄, are advantageous. If the metal M is Y then nitrates are preferred, in particular Y(NO₃)₃·6H₂O. If the metal M is Sb then halides, in particular chlorides, preferably SbCl₃, are advantageous. If the metal M is In then carboxylates, in particular acetylacetonates, preferably In(acac)3, are advantageous.

As mentioned before, alkoxides are preferred precursors. Suitable alkoxides are in particular C₁-C₈-alkoxides, preferably C₁-C₅-alkoxides such as methoxides, ethoxides, n-propoxides, isopropoxides, n-butoxides, isobutoxides, sec-butoxides, tert-butoxides, n-pentoxides and isopentoxides. Particularly preferred are C₁-C₄-alkoxides such as methoxides, ethoxides, n-propoxides, isopropoxides, n-butoxides, isobutoxides, sec-butoxides and tert-butoxides, in particular n-propoxides, isopropoxides, n-butoxides and isobutoxides, or mixtures thereof.

Component (A)

According to the invention, the metal oxide nanoparticles are prepared by means of reacting the at least one metal oxide precursor (P) with at least one monofunctional alcohol (A) in which the hydroxy group is bound to a secondary, tertiary or α-unsaturated carbon atom.

The term “monofunctional” refers to the presence of one hydroxyl group.

The function of the alcohol (A) in the present invention is to serve as a source of oxygen for the formation of metal oxides, as reaction medium and as a dispersing liquid (referred to as a solvent).

In principle, any monofunctional alcohol (A) as defined above can be used provided it serves as a source of oxygen during the formation of the metal oxide. It turned out to be advantageous to use alcohols in which the hydroxyl group is attached to an organic rest which is capable of forming stabilized carbocations.

Suitable monofunctional alcohols (A) include benzyl alcohol, benzyl alcohols substituted in the aromatic ring, secondary alcohols such as isopropanol or higher homologues, and tertiary alcohols such as tert-butylacohol or pinacol (1,1,2,2-tetramethylethylene glycol). The most preferred alcohol (A) is benzyl alcohol.

Preferred monofunctional alcohols (A) are aliphatic alcohols with from 4 to 30 carbon atoms with the hydroxyl group bound to a tertiary or benzylic carbon atom. Correspondingly the monofunctional alcohol (A) is advantageously a compound according to the formula R⁶—OH, wherein R⁶ is selected from tertiary alkyl groups with from 4 to 20 carbons atoms and benzylic groups with from 7 to 30 carbon atoms.

The term “benzylic group” and correspondingly “benzylic carbon atom”, in accordance to the IUPAC Compendium of Chemical Terminology 2nd Edition (1997), refers to arylmethyl groups and their derivatives formed by substitution according to the general structure ArCR₂— wherein each R independently represents hydrogen or a linear or branched aliphatic group or an aromatic group. Benzyl, C₆H₅CH₂—, is the most preferred benzylic group.

It is particularly preferred to use benzyl alcohol as the monofunctional alcohol (A).

Component (F)

According to the invention, the metal oxide formation takes place in the presence of at least one aliphatic compound (F) according to the formula Y¹—R¹—X—R²—Y², wherein
R¹ and R² each are the same or different and independently selected from aliphatic groups with from 1 to 20 carbon atoms,
Y¹ and Y² each are the same or different and independently selected from OH, NH₂ and SH, and
X is selected from the group consisting of chemical bond, —O—, 'S—, —NR³—, and —CR⁴R⁵, wherein R³, R⁴ and R⁵ each are the same or different and represent a hydrogen atom or an aliphatic group with from 1 to 20 carbon atoms which optionally carries functional groups selected from OH, NH₂ and SH.

Preferably at least one of Y¹ and Y² represents OH and very preferably both, Y¹ and Y², represent OH. It is preferred if Y¹ and Y² are in 1,3-position to each other.

According to a first preferred embodiment, X represents an oxygen atom. Preferred compounds (F) with X=O are glycol ethers (X=O and Y¹=Y²=OH).

Suitable glycol ethers are well-known glycol ethers such as ethylene glycol mono-methyl ether, ethylene glycol monoethyl ether, ethylene glycol mono-n-propyl ether, ethylene glycol monoisopropyl ether, ethylene glycol mono-n-butyl ether, ethylene glycol monoisobutyl ether, ethylene glycol mono-sec-butyl ether, ethylene glycol tert-butyl ether, diethylene glycol monomethyl ether, diethylene glycol monoethyl ether, diethylene glycol mono-n-propyl ether, diethylene glycol monoisopropyl ether, diethylene glycol mono-n-butyl ether, diethylene glycol monoisobutyl ether, diethylene glycol mono-sec-butyl ether, diethylene glycol tert-butyl ether, preferably ethylene glycol monoethyl ether, ethylene glycol mono-n-propyl ether, ethylene glycol monoisopropyl ether, ethylene glycol mono-n-butyl ether, ethylene glycol monoisobutyl ether, ethylene glycol mono-sec-butyl ether, ethylene glycol tert-butyl ether, diethylene glycol monoethyl ether, diethylene glycol mono-n-propyl ether, diethylene glycol monoisopropyl ether, diethylene glycol mono-n-butyl ether, diethylene glycol monoisobutyl ether, diethylene glycol mono-sec-butyl ether and diethylene glycol tert-butyl ether, particularly preferably ethylene glycol mono-n-propyl ether, ethylene glycol monoisopropyl ether, ethylene glycol mono-n-butyl ether, ethylene glycol monoisobutyl ether, ethylene glycol mono-sec-butyl ether, ethylene glycol tert-butyl ether, diethylene glycol mono-n-propyl ether, diethylene glycol monoisopropyl ether, diethylene glycol mono-n-butyl ether, diethylene glycol monoisobutyl ether, diethylene glycol mono-sec-butyl ether and diethylene glycol tert-butyl ether, in particular ethylene glycol monoisopropyl ether, ethylene glycol monoisobutyl ether, ethylene glycol tert-butyl ether, diethylene glycol monoisopropyl ether, diethylene glycol monoisobutyl ether and diethylene glycol tert-butyl ether.

From the compounds listed above, glycol ethers with two hydroxyl groups (Y¹=Y²=OH) in 1,3-position are preferred.

According to a second preferred embodiment X represents a sulfur atom. If X=S then bis-(2-chloroalkyl)sulfides are particularly preferred and bis-(2-chloroethyl)sulfide is very particularly preferred.

According to a third preferred embodiment X is selected from NH and NR³with R³ having the meaning as defined above. If X=NH then diethanol amine is particularly preferred. If X=NR³ then triethanol amine is particularly preferred.

According to yet another preferred embodiment, which is particularly preferred, X represents a chemical bond. It is advantageous if X is a chemical bond and Y¹ and Y² are in 1,3-position to each other.

Preferably at least one of Y¹ and Y² represents OH and very preferably both, Y¹ and Y², each represent OH and at the same time X=chemical bond.

Suitable at least bifunctional alcohols (Y¹=Y²=OH and X=chemical bond) preferably contain from two to five hydroxyl groups. Examples are C₂-C₆-alkylene glycols and the corresponding di- and polyalkylene glycols, such as ethylene glycol (1,2-ethane diol), 1,2-propylene glycol (1,2-propane diol), 1,3-propane diol, 1,2-butylene glycol, 1,4-butylene glycol, 1,6-hexylene glycol, dipropylene glycol, glycerol and pentaerythritol as well as 1,2,3,4,5,6—hexahydroxyhexane and sugars.

The function of the aliphatic compound (F) is to serve as a surface modifying agent for the metal oxide nanoparticles. Its use offers several advantages, one of which is to stabilize the surface of the nanoparticles and prevent their agglomeration during a subsequent re-dispersion. Another advantage is the significant improvement with respect to the speed and quantity of re-dispersability of the metal oxide nanoparticles.

In a very particularly preferred embodiment, the aliphatic compound (F) is 1,3-propane diol.

In a preferred embodiment the method for making metal oxide nanoparticles according to the invention comprises the following steps:
(a) mixing of the at least one metal precursor (P), the at least one alcohol (A), and the at least one aliphatic compound (F) where the components (P), (A) and (F) have the meaning as defined above,
(b) heating the mixture to a temperature of from 40 to 200° C. and
(c) obtaining the metal oxide nanoparticles as a solid compound.

Step (a)

According to this preferred embodiment step (a) comprises mixing the at least one metal oxide precursor (P) with the at least one alcohol (A) and the at least one aliphatic compound (F). Preferred embodiments concerning the components (P), (A) and (F) are outlined above.

As means of mixing methods known to the person skilled in the art can be applied such as stirring. The mixing in principle can take place in any sequence. In a preferred embodiment, component (P) is added to component (A) under stirring. Component (F) is preferably added at last. Alternatively, component (P), neat or pre-solved in a suitable solvent, preferably an alcohol, can be added to the mixture of component (A) and component (F).

It is preferred to pre-solve component (P) in a suitable solvent, in particular a monofunctional primary aliphatic alcohol, preferably ethanol. Said solvent used for presolving component (P) can be identical to the alcohol (A) or can be a different suitable solvent.

Advantageously the viscosity of the solvent used for pre-solving component (P) has a lower viscosity than alcohol (A). The advantage of using a low-viscosity solvent lies in the rapid mixing in relation to the reaction rate.

By means of pre-solving component (P) it is possible to control the formation of the metal oxide while reducing the reactivity of the precursor. As an example, TiCl₄ reacts very aggressively with benzyl alcohol, and sufficient mixing is difficult to achieve in benzyl alcohol due to its inherent viscosity.

According to one embodiment, the formation of the nanoparticulate metal oxide is facilitated by means of addition of water and/or an acid. Suitable acids include aqueous solutions of mineral acids, in particular hydrochloric acid with a concentration of 1 to 35% by weight. Preferably water an/or a mineral acid is added in an amount of 0,1 to 10 parts by weight, preferably 0.5 to 5 parts by weight in relation to 100 parts by weight of components (P), (F) and (A).

The function of the addition of water and/or acid is to facilitate the initial hydrolysis of the precursor. It is however preferred to conduct the reaction in the absence of water or to conduct the reaction without any additional water apart from the water which may be contained as ligand in the metal oxide precursor.

The ratio of components (P), (A) and (F) in the reactive mixture can vary over a broad range. Preferably, said mixture contains from 1 to 20% by weight of component (P), from 0.1 to 5% by weight of component (F) and from 75 to 98.9% by weight of component (A), where the sum of the % by weight of components (P), (F) and (A) is 100% by weight. In a particularly preferred embodiment, the mixture contains from 4 to 12% by weight of component (P), from 0.5 to 2% by weight of component (F) and from 86 to 95.5% by weight of component (A), where the sum of the % by weight of components (P), (F) and (A) is 100% by weight.

Step (b)

Step (b) comprises the thermal treatment of the mixture obtained according to step (a). According to step (b) said mixture is preferably heated to a temperature of from 40 to 200° C., particularly preferred to a temperature of from 50 to 180° C., in particular from 60 to 140° C.

An increased temperature is advantageous in order to increase the reaction rate of the condensation reaction and to induce the nanoparticle formation. The temperature and duration of the thermal treatment influences the size of the nanoparticles and their crystallinity. In general, a long heating time leads to the formation of larger particles whereas a short heating period leads to the formation of small particles. With increased temperature, the nanoparticle size increases faster and the nanoparticles show an increased crystallinity as measured by x-ray diffraction.

The temperature according to step (b) can therefore be adjusted for a given metal oxide material in order to control particle size and crystallinity. A low reactivity of certain less reactive precursors can be compensated by application of higher temperatures.

Typically, reaction temperatures under 100° C. support the formation of amorphous nanoparticles and temperatures over 100° C. support the formation of crystalline nanoparticles. By means of using temperatures of from 100 to 200° C., nanoparticles with a crystallinity as measured by x-ray diffraction (XRD) of up to 100% can be achieved. The person skilled in the art determines a suitable temperature according to step (b) through simple routine testing depending on the crystallinity required and depending on the nature of the metal oxide.

By adjusting the temperature it is also possible to obtain nanoparticles with a crystalline core and an amorphous shell.

Partially crystalline and partially amorphous nanoparticles can be crystallized by subsequent calcination at temperatures in the range of from 150 to 300° C. whereas partially crystalline metal oxide nanoparticles produced with methods known from the prior art require temperatures of at least 400° C.

The duration of step (b), i.e., the dwell time, can vary over a broad range and depends on the type of metal oxide nanoparticles. Suitable dwell times typically range from 0.5 to 24 hours, preferably from 1 to 18 hours, in particular from 2 to 14 hours. Heating and cooling rates do not show a significant influence on the outcome of the reaction. The person skilled in the art determines a suitable dwell time by routine testing.

The thermal treatment can be performed in typical vessels or reactors known to the person skilled in the art, e. g., in a glass vessel under normal pressure or in an auto-clave.

Step (c)

According to step (c) of the preferred method the metal oxide nanoparticles are obtained as a solid compound.

In principle, different means of obtaining solid metal oxide nanoparticles can be used. Corresponding methods are known to the person skilled in the art. Preferably, the metal oxide is obtained as a precipitate in the course of step (b) or thereafter, in particular after inducing precipitation which is preferred. In order to induce precipitation it is preferred to combine the product obtained after step (b) with a poor solvent.

According to step (c) of a particularly preferred method, the metal oxide nanoparticles are precipitated by means of adding a poor solvent to the product obtained after step (b) and subsequently obtaining the precipitate as a solid compound.

The nanoparticles in some cases directly precipitate on the walls of the reaction vessel and can be collected by simple means of separation known to the person skilled in the art. Alternatively, which is preferred, the reaction mixture is added to a poor solvent in order to induce the precipitation of the nanoparticulate metal oxide. Preferably the rate of addition to the poor solvent is low so that the addition takes a period of time from about 30 seconds to 10 minutes.

Suitable poor solvents capable of inducing the precipitation of the nanoparticles include ethers, in particular diethyl ether, acetates, in particular ethylacetate, linear or branched hydrocarbons, and aromatic solvents, in particular toluene and/or xylenes. The most preferred poor solvent is diethyl ether.

It is preferred to perform the precipitation at a temperature of room temperature or below room temperature, in particular of from −5° C. to 20° C. To that end, the poor solvent, the reaction product of step (b) or both, the poor solvent and the reaction product of step (b) are kept at a temperature of from −5° to 20° C. The temperature of the poor solvent when combined with the product of step (b) preferably is from −10° C. to +10° C., in particular from −5° C. to +5° C. At the same time it is preferred if the reaction mixture obtained after step (b) has a temperature of from 10° C. to 30° C. when it is combined with the poor solvent, preferably from 15° C. to 25° C., in particular room temperature.

Preferably, the reaction mixture obtained in step (b) is added to the poor solvent under stirring. Alternatively, the poor solvent may be added to the reaction mixture. After having obtained the solid nanoparticulate metal oxide, the remaining liquid can be removed by methods known to the person skilled in the art.

The precipitate formed is subsequently separated from the mother solution using techniques known to person skilled in the art, in particular centrifugation, filtration or sedimentation. The most preferred method of removing the remaining liquid is centrifugation, preferably at a rotational speed of about 1000 to 8000 rpm, particularly preferably from 3000 to 5000 rpm.

The liquid is then separated from the solid and the solid residue can be re-suspended in the poor solvent and separated again in order to purify the particles. Typically, subsequent re-suspension and removing the liquid is performed at least once, advantageously at least twice.

The metal oxide nanoparticles obtainable by the inventive method are characterized by a number-average particle diameter of from 1 to 100 nm, preferably from 5 to 50, in particular from 5 to 30 nm. The average particle diameter throughout the present invention refers a number-average d[1.0] value obtained by means of light scattering.

The metal oxide nanoparticles according to the invention can be further used as precursors for the preparation of nanostructured materials and for the preparation of thin films which are characterized by high transparency and low haze. Suitable methods of thin film production include solution coating methods, in particular spraying, spin and dip coating, as well as roll-to-roll processes. The metal oxide nanoparticles obtainable by the inventive method can also be used as abrasives for CMP (Chemical Mechanical Polishing) or for the formulation of printable inks.

Once the solid nanoparticulate metal oxides have been obtained they can advantageously be re-dispersed in a suitable solvent. The metal oxide nanoparticles according to the invention are easily re-dispersible in many organic solvents, in particular aliphatic alcohols, preferably ethanol, methanol or isopropanol, or ethers, in particular THF. In particular, the metal oxide nanoparticles according to the invention can be re-dispersed in said organic solvents even after having been dried at moderate temperatures of below 60° C. under vacuum.

The optional step of re-dispersing the nanoparticles according to the invention is described in the following and referred to as step (d). Optional step (d) is preferably applied subsequently to steps (a) to (c) as outlined above but can be applied to the nanoparticles obtainable according to the invention in general. The dispersions obtainable by means of re-dispersing the metal oxide nanoparticles according to the invention as well as dispersions containing said nanoparticles in a solvent are also a subject of the present invention.

The term “dispersion” refers to a stable dispersion of solid nanoparticles in a liquid dispersing agent which is referred to as a solvent. Dispersions are free of aggregates and exhibit stability with respect to precipitation of at least 1 day, preferably at least 10 days, in particular at least 100 days. In the context of the present invention dispersions are free of aggregates, if the dispersions show no haze according to DIN EN ISO 15715:2006. For the purpose of the present invention, “no haze” shall mean an NTU (Nephelometric Turbidity Unit) or FTU (Formazine Turbidity Unit) according to DIN EN ISO 15715:2006, measurement angle 90° , of below 10, preferably of below 3, in particular of below 1.

Step (d)

In a preferred embodiment according to step (d), the metal oxide nanoparticles according to the invention are re-dispersed in an organic solvent yielding a dispersion of metal oxide nanoparticles. By this means, the inventive nanoparticles are converted into a stable dispersion in a suitable solvent, preferably an organic solvent, particularly preferred a polar organic solvent.

A preferred method for making dispersions containing the nanoparticles according to the invention comprises:
performing steps (a) to (c) as outlined above and subsequently
(d) re-dispersing the solid metal oxide nanoparticles obtained in step (c) in a solvent, preferably an organic solvent.

By means of the preferred method optically clear and transparent dispersions (no haze according to DIN EN ISO 15715:2006 due to agglomerates) can be obtained without application of any means of deagglomeration such as stabilizing agents or mechanical forces.

Re-dispersion according to step (d) can be applied subsequently to steps (a) to (c) without previous drying of the nanoparticles obtained in step (c). Alternatively, the nanoparticulate metal oxide according to the invention can be dried under mild conditions, preferably at a temperature of from 20° C. to 80° C., in particular from 40° C. to 60° C., before applying step (d). The drying can take place at atmospheric pressure or under vacuum. The drying can take place under air or under an inert gas if required.

The resulting dispersions are optically clear and free of aggregates. Said dispersions remain stable upon addition of co-solvents, e.g. water, and other additives such as in particular surfactants. In other words, the addition of said compounds does not induce precipitation of the nanoparticles, i. e., no turbidity or gelation occurs.

Optional step (d) therefore comprises the re-dispersion of the metal oxide nanoparticles according to the invention in a suitable organic solvent without addition of surface modifying agent. The nanoparticles according to the invention can simply be mixed and/or stirred with a suitable solvent, in particular a polar organic solvent, preferably an alcohol, THF, acetone or a halogenated hydrocarbon.

Particularly preferred solvents for re-dispersing the metal oxide nanoparticles according to the invention are monofunctional alcohols with from 1 to 4 carbon atoms, in particular methanol and/or ethanol. The optically clear and stable dispersion is obtained immediately upon mixing and/or stirring or the mixture becomes clear within a period of from 0.1 to 30 minutes.

In some cases, ultrasonic vibrations may be used to accelerate the re-dispersion process according to step (d). Corresponding methods are known to the person skilled in the art.

The optically clear dispersions obtained after re-dispersion are characterized by the presence of non-agglomerated individual nanoparticles. The dispersions remain stable at room temperature at concentrations up to 25 weight % and can be diluted by addition of further suitable solvents. Preferably the solvent used for dilution is the same solvent which has been used for re-dispersing the nanoparticles according to the invention. Alcohols, in particular methanol and/or ethanol, and ethers, in particular THF are preferred. Non-polar solvent such as hydrocarbons, aliphatic ethers, in particular diethyl ether, aromatic compounds, like toluene, xylenes should be avoided.

Another subject of the present invention are metal oxide nanoparticles obtainable according to the method of the present invention and dispersions containing said metal oxide nanoparticles. Said dispersions are in particular obtainable by means of redispersing the metal oxide nanoparticles according to the invention in an organic solvent. Said dispersions are in particular suitable for making metal oxide coatings which are highly transparent and free of haze.

### EXAMPLES

Methods: The number-average particle diameter was determined with dynamic light scattering in a 2.5% by weight solution in methanol at a temperature of 20° C. The crystallinity was determined by x-ray diffraction at a temperature of 20° C. Re-dispersion was performed by means of placing the nanoparticulate powder in a glass vial equipped with a magnetic stirring bar followed by addition of the re-dispersing agent (solvent) in an amount yielding a dispersion with a solid content of 14% by weight and stirring at 300 rpm at 20° C. for 5 minutes after which the dispersion became clear. The turbidity (haze) was determined according to DIN EN ISO 15715:2006 after diluting the dispersion to a solid content of 2.5% by weight.

Synthesis of amorphous and crystalline TiO₂

### Example 1

### Amorphous TiO₂

3,4 g of TiCl₄ was added into 7,9 g of ethanol under intensive stirring. The resulting solution was added to 42 g of benzyl alcohol, followed by addition of 400 mg of 1,3-propanediol. The reaction mixture was stirred at 80° C. for 8 hours under air. After cooling down, the nanoparticles were precipitated by addition of 8 g of the resulting solution into 18 g of cold diethyl ether. The precipitate was centrifuged at 7000 rpm for 10 minutes and then re-suspended twice in pure diethyl ether and centrifuged in order to wash out the impurities. The solid was re-dispersed in 3 g of ethanol using an ultrasonic bath to accelerate the re-dispersion.

### Example 2

### Amorphous TiO₂

10,4 g of Ti(OiPr)₄ was added under vigorous stirring into the mixture of 15,8 g of ethanol and 1.6 g of concentrated aqueous solution of HCl. The resulting mixture was added to 80 g of benzyl alcohol, followed by addition of 0.96 g of 1,3-propanediol. The reaction mixture was stirred at 70° C. for 12 hours under air. After cooling down to room temperature the reaction mixture was slowly poured into 1200 ml of diethyl ether. The precipitate was separated using centrifugation and washed twice with diethyl ether as in Example 1. The nanoparticles were dried under ambient conditions under air and then re-dispersed in methanol to obtain a stable, clear, and colorless dispersion of TiO₂ with a TiO₂ content of up to 15 wt %.

### Example 3

### Crystalline TiO₂

The synthesis was performed as described in synthesis 1. The solid TiO₂ nanoparticles prior to re-dispersion were calcined at 110° C. for 1, 2, 3, and 4 hours. The nanoparticles were then re-dispersed in the same manner as in Example 1 yielding fully transparent dispersions.

The effect of the reaction time on the average particle diameter is summarized in table 1.

TABLE 1
Effect of calcination time on the structure
of particles according to Example 3

| Reaction time | Mean crystallite | Crystallinity | Average particle |
|---|---|---|---|
| (calcination) | size [nm] | [%] | diameter [nm] |
| 1 h | 2.5 | >80 | 10 |
| 2 h | 3 | >90 | 20 |
| 3 h | 3.5 | >90 | 30 |
| 4 h | 3.5 | >90 | 60 |

### Example 4a-f

### Synthesis of Nb₂O₅, Ta₂O₅, HfO₂, ZrO₂, Mn₂O₃ and Al₂O₃ Nanoparticles

3 g NbCl₅ (Example 4a), 3 g Ta(OEt)5 (Example 4b), 3 g HfCl₄ (Example 4c), 3 g ZrCl₄ (Example 4d), 2 g Mn(NO3)2·xH₂O (Example 4e) or 3 g AlCl₃ (Example 4f) were dissolved in 5 ml of ethanol and the resulting solution was added into 40 ml of benzyl alcohol followed by the addition of 0.5 g of 1,3-propane diol. After thermal treatment at 80° C. for 12 h the reaction mixture was precipitated by addition of diethyl ether and washed twice. The obtained nanoparticles were re-dispersed in 6-10 ml of methanol.

### Example 5a-c

### Synthesis of Fe₂O₃, Cr₂O₃ and V₂O₅ Nanoparticles

2 g of Fe(NO₃)₃·9H₂O (Example 5a), 2 g of Cr(NO₃)₃·9H₂O (Example 5b) or 1 g V(OEt)₃ (Example 5c) were dissolved in 5 ml of ethanol and the resulting mixture was added to 40 ml of benzyl alcohol, followed by 0.5 g of 1,3-propane diol. The reaction mixture was thermally treated at 60° C. for 1 h and precipitated by addition into diethyl ether. After washing twice with the diethylether and drying under air, the powders were redispersed in 6 to 10 ml of methanol.

### Example 6

### Synthesis of RuO₂ Nanoparticles

1 g of RuCl₃·xH₂O was carefully dissolved in 5 ml of ethanol and the resulting solution was added into benzyl alcohol, followed by addition of 0.5 g of 1,3-propane diol. The reaction mixture was stirred at 130° C. for 1 h and then precipitated with diethyl ether. The resulting precipitate was centrifuged and washed twice with diethylether. The nanoparticles were dried under air and re-dispersed in 4 ml of methanol.

### Example 7

### Synthesis of ATO (Antimony Tin Oxide) Nanoparticles

2.2 g of SnCla was slowly added into 16 g of benzyl alcohol under vigorous stirring. To the resulting solution, 0.193 g of SbCl₃ dissolved in 5 g of benzyl alcohol was added, followed by the addition of 0.2 g of 1,3-propane diol. The reaction mixture was stirred at 110° C. for 18 h. During that reaction time, brown ATO nanoparticle precipitated as a deposit on the wall of the reaction vessel. After removal of the liquid, the solid deposit was suspended in 10 ml of acetone and separated using a centrifuge. The resulting solid was re-dispersed in 15 ml of THF to give a clear dispersion with brown color.

### Examples 8a and b

### Synthesis of YSZ (Yttria Stabilized Zirconia) and PZT (Lead Zirconate Titanate) Nanoparticles

2 g of ZrCl₄, 0.525 g of Y(NO₃)₃·6H₂O (Example 8a: for preparation of 16 mol. %-YSZ) or 1 g of Pb(OAc)₂·3H₂O, 0.431 g of Ti(OBut)₄ and 0.526 g of Zr(OBut)₄ (Example 8b: for preparation of Pb(Ti_{0.48}Zr_{0.52})O₃) were dissolved in 5 ml of ethanol. The resulting solution was added in 40 ml of benzyl alcohol, followed by the addition of 0.5 ml of 1,3-propane diol. The reaction mixture was stirred at 80° C. for 8 h. The nanoparticles were then precipitated by pouring into diethyl ether and washed twice with diethyl ether. After drying under air, the nanoparticles were re-dispersed in 8-10 ml of methanol.

The re-dispersion according to examples 4 to 8 always led to optically clear dispersions according to haze measure (less than 10 NTU or FTU units according to DIN EN ISO 15715:2006). The table contains values for 2.5% metal oxide dispersions in methanol measured at 25° C.

The results of the haze measurements for various dispersions of metal oxides (solid content 2.5% by weight) are summarized in Table 2.

TABLE 2
NTU/FTU values determined according
to DIN EN ISO 15715:2006.

| Re-dispersion | |
|---|---|
| according to example | NTU/FTU |
| 5c | <1.00 |
| 5a | 9.22 |
| 4f | <1.00 |
| 4c | <1.00 |
| 5b | <1.00 |
| 2 | 2.46 |
| 4d | <1.00 |

1. Method of making metal oxide nanoparticles comprising the reaction of
at least one metal oxide precursor (P) containing at least one metal (M) with
at least one monofunctional alcohol (A) where the hydroxy group is bound to a secondary, tertiary or α-unsaturated carbon atom
in the presence of at least one aliphatic compound (F) according to the formula Y¹—R¹—X—R²—Y², wherein
R¹ and R² each are the same or different and independently selected from aliphatic groups with from 1 to 20 carbon atoms,
Y¹ and Y² each are the same or different and independently selected from OH, NH₂ and SH, and
X is selected from the group consisting of chemical bond, —O—, —S—,—NR³—, and —CR⁴R⁵, wherein R³, R⁴ and R⁵ each are the same or different and represent a hydrogen atom or an aliphatic group with from 1 to 20 carbon atoms which optionally carries functional groups selected from OH, NH₂ and SH.

2. Method according to claim 1, wherein the metal oxide precursor (P) is an ionic metal compound selected from the group consisting of halides, sulphates, phosphates, nitrates, carbonates, anions of carboxylic acids, acetylacetonate, acetylacetate, alcoxides and mixtures thereof.

3. Method according to claim 1, wherein the metal (M) is selected from at least one of the group consisting of transition metals, Al, Sn, Sb, Pb, In, and Ba.

4. Method according to claim 1, wherein the metal is selected from at least one of Ti, Nb, Ta, Zr, Mn, Al, Fe, Cr, Sn, Sb, Pb, Ce, In, Ba and V.

5. Method according to claim 1, wherein X is a chemical bond.

6. Method according to claim 5, wherein Y¹ and Y² are in 1,3-position to each other.

7. Method according to claim 1, wherein at least one of Y¹ and Y² is OH.

8. Method according to claim 1, wherein the aliphatic compound LFi is 1,3-propane diol.

9. Method according to claim 1, wherein the alcohol (A) is a compound according to the formula R⁶—OH, wherein R⁶ is selected from tertiary alkyl groups and benzylic groups.

10. Method according to claim 1, wherein the alcohol (A) is benzyl alcohol.

11. Method of making metal oxide nanoparticles comprising
(a) mixing of at least one metal precursor (P), at least one alcohol (A), and at least one aliphatic 1,3-bifunctional compound (F) each as defined in claim 1;
(b) heating the mixture to a temperature of from 40 to 200° C.; and
(c) obtaining the metal oxide nanoparticles as a solid compound.

12. Method according to claim 11, wherein the at least one metal oxide precursor (P) is pre-solved in a primary alcohol.

13. Method according to claim 11, wherein according to step (b) said mixture is heated to a temperature in the range of 40 to 200° C. for at least 2 hours.

14. Method according to claim 11, wherein according to step (c) the metal oxide nanoparticles are precipitated by adding to the heated mixture a poor solvent and subsequently obtained as a solid compound.

15. Metal oxide nanoparticles obtainable according to claim 1.

16. Method of making dispersions of metal oxide nanoparticles, the method comprising dispersing metal oxide nanoparticles according to claim 15 in a solvent.

17. Method of making dispersions of metal oxide nanoparticles, the method comprising
(a) mixing of at least one metal precursor (P), at least one alcohol (A), and at least one aliphatic 1,3-bifunctional compound (F) each as defined in claim 1;
(b) heating the mixture to a temperature of from 40 to 200° C.; and
(c) obtaining the metal oxide nanoparticles as a solid compound
and subsequently (d) re-dispersing said metal oxide nanoparticles in a solvent.

18. Dispersions containing metal oxide nanoparticles according to claim 15.

19. Method according to claim 12, wherein the primary alcohol is ethanol.

20. Method according to claim 16, wherein the solvent is a polar organic solvent.
